(19) United States
(12) Patent Application Publication
(10) Pub. No.: US 2016/0023875 A1
(43) Pub. Date: Jan. 28, 2016

(54) ATTACHABLE BOTTLE OPENER SYSTEM AND METHOD OF USE

(71) Applicant: Todd N. Lenig, Ankeny, IA (US)

(72) Inventor: Todd N. Lenig, Ankeny, IA (US)

(21) Appl. No.: 14/797,645

(22) Filed: Jul. 13, 2015

Related U.S. Application Data
(60) Provisional application No. 62/028,087, filed on Jul. 23, 2014.

(51) Int. Cl. B67B 7/16

(52) U.S. Cl. CPC B67B 7/16

(57) ABSTRACT

A bottle opener is presented that can be installed on the handle bars of a conventional bicycle. The bottle opener is formed of a main body, and an expansion mechanism, a plug and a fastener. The plug, expansion mechanism and rearward end of the main body is inserted in an open end of a handle bar of a bicycle and the fastener is tightened. This causes the expansion mechanism to expand and tighten against the interior surface of the handle bars thereby holding it in place. The expansion mechanism is formed of a plurality of wedges that are held together by a binder. The main body includes a notch and a lip that can be easily used to remove bottle caps. The main body also includes an exterior surface that can be used for advertising purposes.

### CROSS REFERENCE TO RELATED APPLICATION

This application claims the benefit of U.S. Provisional Application No. 62/028,087 filed Jul. 23, 2014.

### FIELD OF THE INVENTION

This invention relates to bottle openers. More specifically, and without limitation, this invention relates to a bottle opener that can be attached to various objects such as a bicycle.

### BACKGROUND OF THE INVENTION

In 1891 William Painter filed a patent application entitled a “Bottle-Sealing Device” for an improved method of sealing carbonated bottles of soda and beer to preserve their freshness. This patent application was later issued into U.S. Pat. No. 468,226 in 1892 (which is fully incorporated by reference herein including any and all citing references). The invention became widely accepted and Mr. Painter went on to found Crown Cork & Seal Company of Baltimore, Maryland, which experienced a tremendous amount of success bringing to market what is now colloquially known the “bottle cap”.

While Mr. Painter's invention solved the problem of how to seal a carbonated bottle of soda or beer, Mr. Painter's invention simultaneously created a new problem. That is, how these new sealed bottles are to be opened? To solve this new problem, bottle openers were developed.

Bottle openers were developed that include a handle with an opening and a lip thereon or therein. To open a bottle, a flange of the bottle cap was placed under the lip and the handle is leveraged against the bottle cap thereby separating the bottle cap from the bottle.

While this arrangement certainly proved effective at removing bottle caps, the need to carry a separate device that is used to open bottles proved inconvenient. It was found that this separate bottle opener device was often lost or left behind. This is especially true when the user is mobile, such as on a bike ride. Additionally many bottle openers are large, bulky and heavy and therefore it is inconvenient to bring these bottle openers on trips, such as on a bike ride.

One solution to large bulky bottle openers was to make bottle openers of a smaller stature. However, the smaller the bottle opener the more difficult it is to remove the bottle cap because they lack the leverage of larger bottle openers. Another disadvantage to smaller bottle openers is that they smaller they are, the easier it is to lose or misplace them.

Therefore, in view of the disadvantages in the prior art, for the reasons stated above, and for other reasons stated below which will become apparent to those skilled in the art upon reading and understanding the specification, claims and drawings there is a need in the art for an improved attachable bottler opener system and method.

Thus, it is a primary object of the invention to provide an attachable bottler opener system and method that improves upon the state of the art.

Another object of the invention is to provide an improved attachable bottler opener system and method that is convenient to use.

Yet another object of the invention is to provide an improved attachable bottler opener system and method that is hard to misplace or leave behind.

Another object of the invention is to provide an improved attachable bottler opener system and method that can easily be attached to various devices such as bicycles.

Yet another object of the invention is to provide an improved attachable bottler opener system and method that is durable.

Another object of the invention is to provide an improved attachable bottler opener system and method that has a long useful life.

Yet another object of the invention is to provide an improved attachable bottler opener system and method that has an intuitive design.

Another object of the invention is to provide an improved attachable bottler opener system and method that is formed of a minimum number of parts.

Yet another object of the invention is to provide an improved attachable bottler opener system and method that has a rugged design.

Another object of the invention is to provide an improved attachable bottler opener system and method that is light weight.

Yet another object of the invention is to provide an improved attachable bottler opener system and method that is relatively inexpensive to manufacture.

Another object of the invention is to provide an improved attachable bottler opener system and method that provides value, utility and novelty to the user.

Yet another object of the invention is to provide an improved attachable bottler opener system and method that can easily and efficiently be used to open a bottle in a comfortable and convenient manner.

Another object of the invention is to provide an improved attachable bottler opener system and method that is sized and shaped to be quickly and easily installed on conventional handle bars of bicycles.

Yet another object of the invention is to provide an improved attachable bottler opener system and method that is adjustable.

Another object of the invention is to provide an improved attachable bottler opener system and method that provides for a convenient place for advertising and promotion.

Yet another object of the invention is to provide an improved attachable bottler opener system and method that provides cross-branding and promotional opportunities.

Another object of the invention is to provide an improved attachable bottler opener system and method that can be easily removed and reinstalled.

Yet another object of the invention is to provide an improved attachable bottler opener system and method that can be installed into practically any suitable opening or hole.

These and other objects, features, or advantages of the invention will become apparent from the specification, claims and drawings.

### SUMMARY OF THE INVENTION

A bottle opener is presented that can be installed on the handle bars of a conventional bicycle. The bottle opener is formed of a main body, and an expansion mechanism, a plug and a fastener. The plug, expansion mechanism and rearward end of the main body is inserted in an open end of a handle bar of a bicycle and the fastener is tightened. This causes the expansion mechanism to expand and tighten against the interior surface of the handle bars thereby holding it in place. The expansion mechanism is formed of a plurality of wedges that are held together by a binder. The main body includes a notch and a lip that can be easily used to remove bottle caps. The main body also includes an exterior surface that can be used for advertising purposes.

### BRIEF DESCRIPTION OF THE DRAWINGS

FIG. 1 is a perspective exploded view of a bottle opener system, the view showing the main body, nut or plug, expansion mechanism and fastener;

FIG. 2 is a bottom elevation view of a bottle opener system, the view showing the bottler opener system in an assembled state;

FIG. 3 is a side elevation view of a bottle opener system, the view showing the bottle opener in an assembled state with advertising in the form of a label on the exterior cylindrical surface of the main body;

FIG. 4 is a side elevation view of a bottle opener system, the view showing hidden lines in the main body, expansion mechanism and nut or plug that depict the fastener inserted in the bores therein;

FIG. 5 is a bottom elevation view of the main body of the bottle opener system;

FIG. 6 is a side elevation view of the main body of the bottle opener system;

FIG. 7 is an exploded view of four wedges of the expansion mechanism, each wedge being shown at a different angle;

FIG. 8 includes three views of the plug, the views showing the bore and ramp of the plug; and

FIG. 9 is an exploded perspective view of an alternative arrangement of the bottle opener system , the view showing a cylindrical tube used as the expansion mechanism, and a conventional nut used as the plug, the view also showing a truncated protrusion connected to the rearward end of the main body.

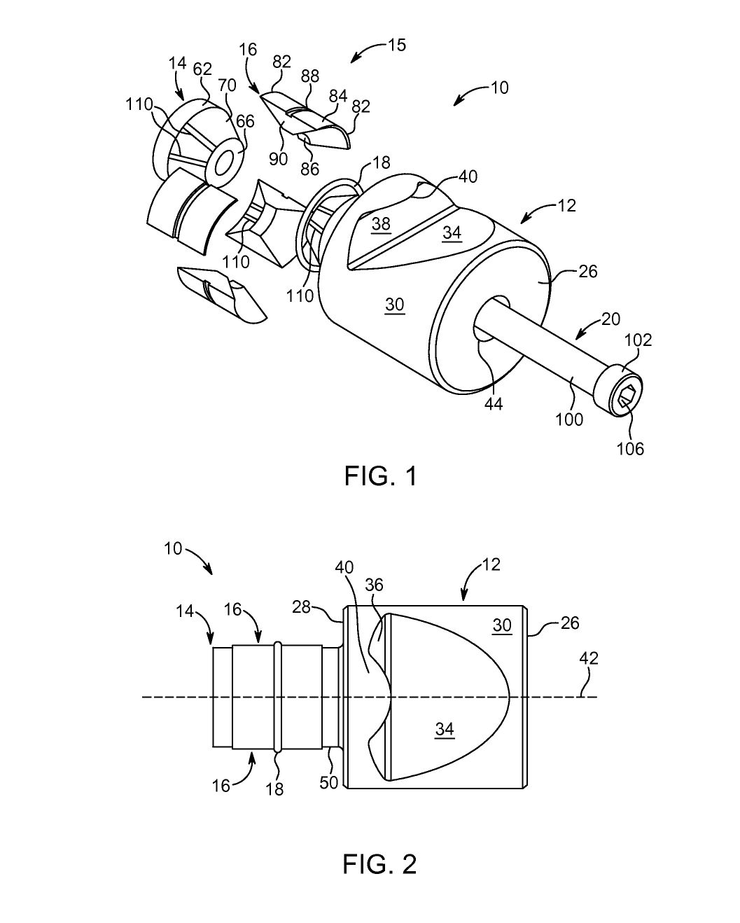

### DETAILED DESCRIPTION OF THE PREFERRED EMBODIMENT

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that mechanical, procedural, and other changes may be made without departing from the spirit and scope of the invention. The following detailed description is, therefore, not to be taken in a limiting sense, and the scope of the invention is defined only by the appended claims, along with the full scope of equivalents to which such claims are entitled.

As used herein, the terminology such as vertical, horizontal, top, bottom, front, back, end, sides, and the like, are referenced according to the views presented. It should be understood, however, that the terms are used only for purposes of description, and are not intended to be used as limitations. Accordingly, orientation of an object or a combination of objects may change without departing from the scope of the invention.

System: With reference to the figures, an improved attachable bottle opener system 10 is presented. The system 10 includes the component pieces of a main body 12, a plug 14, and an expansion mechanism 15 formed of a plurality of wedges 16, an elastic binder 18 and a fastener 20. The system 10 connects to the interior diameter of a tube 22, such as that which forms handle bars on a conventional bicycle 24.

Main Body: The main body 12 is fanned of any suitable size, shape and design. In one arrangement, as is shown, the forward end of main body 12 has a generally flat front face 26, and the rearward end of main body 12 has a generally flat rear face 28, that each define a plane that extend in approximate parallel spaced relation to one another. Main body 12 also includes an exterior surface 30 that connects at its forward edge to front face 26 in a generally perpendicular alignment, and at its rearward edge to rear face 28 also in a generally perpendicular alignment. In the arrangement shown, exterior surface 30 is generally smooth and cylindrical in nature when viewed from the front face 26 or rear face 28, however any other shape is hereby contemplated for use. Main body 12 extends a lateral length between front face 26 and rear face 28.

A notch 32 is positioned in the exterior surface 30 of main body 12 and is positioned in the lateral length of main body 12 between front face 26 and rear face 28. Notch 32 is formed of any suitable size, shape and design. In the arrangement shown, notch 32 is formed of a first wall 34 and a second wall 36 that extend at a generally parallel spaced arrangement to one another. The rearward ends of first wall 34 and second wall 36 connect to, or end at, end wall 38. The plane defined by end wall 38 is positioned in approximate perpendicular alignment to the planes defined by first wall 34 and second wall 36. In this way, notch 32 is generally square or rectangular in nature when viewed from the side.

While notch 32 is generally square in nature when viewed from the side, notch 32 extends into main body 12 at an angle (shown as a on the figures). More specifically, when viewed from the side, first wall 34 and second wall 36 intersect with exterior surface 30 at an angle between 0° and 90°, or, more specifically, such as in the arrangement shown between 15° and 75°. Even more specifically, inn the arrangement shown, as one example, the notch 32 extends at an angle of 24.30° to the plane defined by the exterior surface 30 of main body, however any angle between 0° and 90° is hereby contemplated for use.

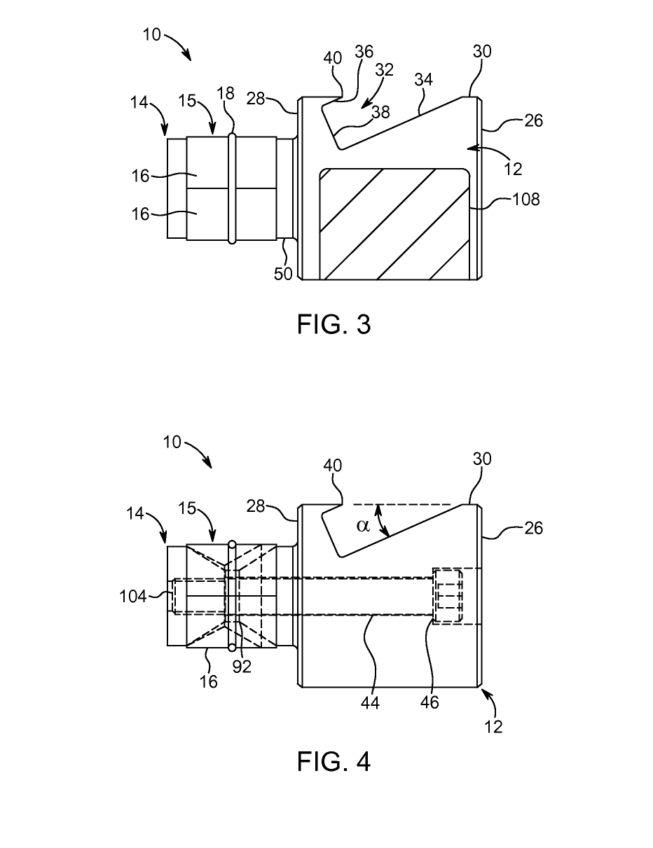

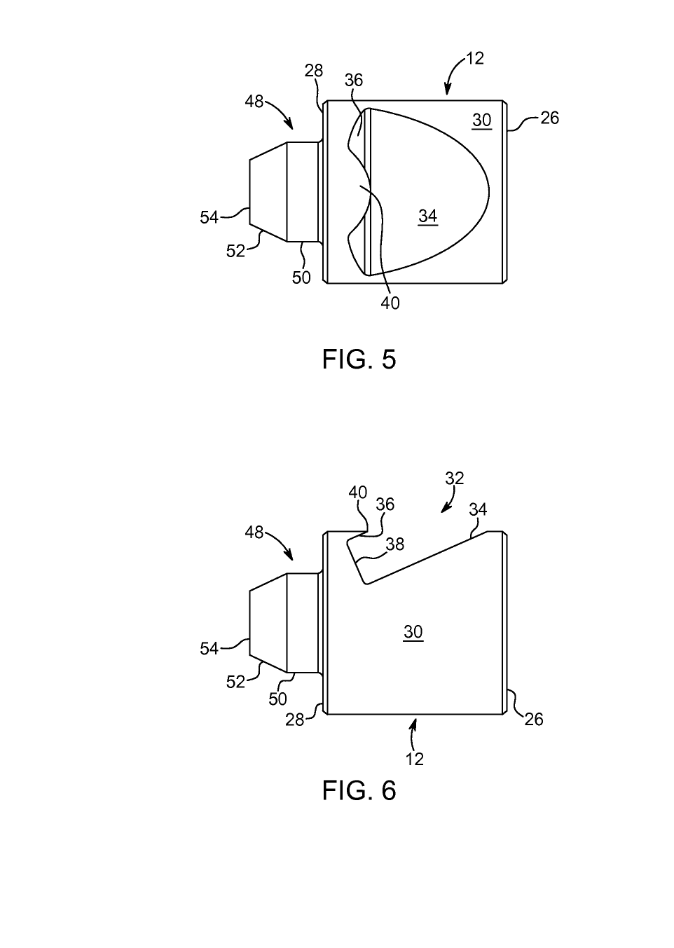

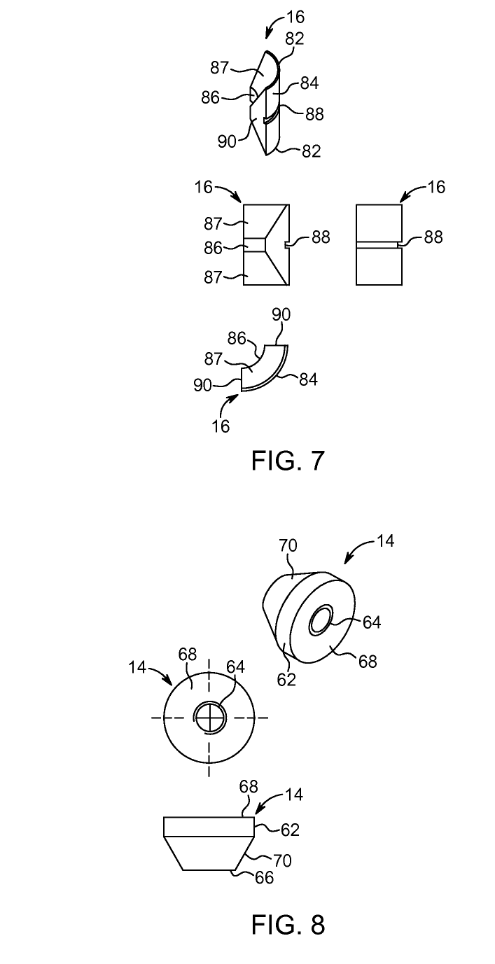

While notch 32 is positioned at an angle a to the exterior surface 30 of main body 12, notch 32 extends perpendicularly across the length of main body 12. Or said another way, notch 32 extends perpendicular to the forward to back length of main body 12. That is, the plane defined by end wall 38 is positioned in perpendicular alignment to the forward to back length of main body 12. In one arrangement, as is shown by the side view of FIGS. 3, 4 and 6, and bottom views of FIGS. 2 and 5, notch 32 cuts perpendicularly across the lateral length of main body 12.

Notch 32 extends far enough into main body 12 to form lip 40. Lip 40 extends forward from end wall 38 a distance. This distance is approximately long enough to grab the flap of a conventional bottle cap as is further described herein. In addition, end wall 38 is long enough to receive the height of a conventional bottle cap between the first wall 32 and second wall 36.

Due to notch 32 extending into main body 12 at an angle a, when viewed from above, the forward ends of first wall 34, second wall 36 and lip 40 are curved or arcuate in nature, which is formed by the intersection of the flat plane of first wall 34 and second wall 36 with the cylindrical exterior surface 30 of main body 12. Because the notch 32 is positioned perpendicular to the length of main body 12, the forward most point of the first wall 34 and second wall (also known as the apex, or tangent point) is centered over the center axis 42 that extends through the center of main body 12. This central positioning of the forward most end of lip 40, as well as the perpendicular alignment of the notch 32 to the forward to back length of main body 12 provides the system 10 with balance and ease of use.

A bore 44 extends through main body 12. Bore 44 is formed of any suitable size, shape and design. In the arrangement shown, bore 44 is generally cylindrical in shape and is approximately centrally positioned within main body 12 and aligned with center axis 42. That is, bore 44 extends in a generally parallel arrangement to the forward to back length of main body 12 and intersects at an approximate perpendicular arrangement to the front face 26 and rear face 28. A shoulder 46 is positioned a distance inward of the front face 26. Shoulder 46 transitions bore 44 from a wider diameter to a narrower diameter.

A protrusion 48 extends rearward out of the rear face 28 of main body 12. Protrusion 48 is formed of any suitable size, shape and design. In the arrangement shown, protrusion 48 is generally cylindrical in nature and is centered on center axis 42. In this way, the cylindrical exterior surface 50 of protrusion 48 is positioned in approximate parallel spaced relation to the cylindrical exterior surface 30 of main body 12. The forward edge of exterior surface 50 connects to rear face 28. The rearward edge of exterior surface 50 connects to ramp 52. Ramp 52 extends inward at an angle from cylindrical exterior surface 50 towards the centrally positioned centered axis 42. In this way, ramp 52 forms a partial portion of a cone that gets narrower as it extends rearward. The rearward edge of ramp 52 connects to rear wall 54. Rear wall 54 defines a plane that is positioned in generally parallel spaced relation to the planes defined by front face 26 and rear face 28, and is positioned in a generally perpendicular arrangement to exterior surface 50.

Plug: System 10 includes a plug 14. Plug 14 is formed of any suitable size, shape and design. In the arrangement shown, plug 14 is formed of a similar size and shape as protrusion 48, only oppositely positioned and unattached to main body 12.

That is, plug 14 is generally cylindrical in nature having a cylindrical exterior surface 62 and a cylindrical bore 64 extending through its middle from front wall 66 to rear wall 68.

The cylindrical exterior surface 62 of plug 14 is positioned in approximate perpendicular relation to plane formed by front wall 66 and rear wall 68. The rear edge of exterior surface 62 connects to rear wall 68 at an approximate perpendicular orientation. The forward edge of exterior surface 62 connects to ramp 70. Ramp 70 extends inward at an angle from cylindrical exterior surface 62 towards the centrally positioned bore 64 and centered axis 42. In this way, ramp 70 forms a partial portion of a cone that gets narrower as it extends forward. The forward edge of ramp 70 connects to front wall 66. Front wall 66 defines a plane that is positioned in generally parallel spaced relation to the plane defined by rear wall 68, and is positioned in a generally perpendicular arrangement to exterior surface 62.

In the arrangement shown, the size and shape of front wall 66 corresponds to rear wall 54; ramp 70 corresponds to ramp 52; exterior surface 62 corresponds to exterior surface 50, bore 64 corresponds to bore 44. In this way, plug 14 and protrusion 48 are identical or approximate mirror images of one another.

Expansion Mechanism: System 10 includes an expansion mechanism 15 which is designed to expand as the plug 14 moves closer to the main body 12, and shrink as the plug 14 moves away from the main body 12. Expansion mechanism 15 is formed of any suitable size shape and design and serves to lock system 10 into place, such as onto the handle bar of a bicycle.

In one arrangement, as is shown, expansion mechanism 15 is formed of one or more wedges 16. Wedges 16 are formed of any suitable size, shape and design. In the arrangement shown, wedges 16 are formed of a partial portion of a cylinder. In the arrangement shown, four wedges 16 are used each wedge being identical or approximately identical to one another and each wedge 16 forming approximately one quarter or 90° of the cylinder that is formed out of all wedges 16 when placed together. However, any other number of wedges are hereby contemplated for use, such as only one, two, three, five, six, seven, eight, nine, ten or more.

Wedges 16 are symmetric about a plane that extends through their middle from side-to-side, as well as from front-to-back. Wedges 16 extend forward to back a length from opposing end 82 to opposing end 82. Wedges 16 have a cylindrical exterior surface 84 and cylindrical interior surface 86. A ramp 87 extends at an angle from ends 82 from the exterior surface 84 to the interior surface 86. In this way, the cylindrical interior surface 86 has a smaller diameter than the cylindrical exterior surface. In addition, the cylindrical interior surface 86 is narrower, forward to back, than the cylindrical exterior surface 84.

A groove 88 is positioned in the cylindrical exterior surface 84 approximately at the midpoint between opposing ends 82. Groove 88 extends in approximate parallel spaced relation to the opposing ends 82 and serves to receive binder 18 or other elastic member.

Wedges 16 terminate at sides 90 which are generally flat and planar in shape. In the arrangement shown, when four wedges 16 are used, the planes that are defined by sides 90 are positioned at approximate perpendicular alignment to one another, or said another way, the sides 90 are at 90° to one another, however this angle changes when more or less wedges are used.

When three wedges 16 are used, then sides 90 are positioned at 120° to one another. When two wedges 16 are used, then sides 90 are positioned at 180° to one another. And so on.

When wedges 16 are positioned in flush side 90 to side 90 alignment, the interior surfaces 86 of adjacent wedges 16 define a bore 92 that is similar to, identical to, or just slightly larger than the bores 44, 64 in main body 12 and plug 16 respectively. Also, in this arrangement, the grooves 88 of adjacent wedges 16 align with one another to form a single continuous groove all the way around all wedges 88, and the ends 82 align with one another.

Once aligned in this side 90 to side 90 alignment, binder 18 is positioned in grooves 88, thereby holding all wedges 16 together. In this arrangement, the binder 18 holds the plurality of wedges 16 together to form the partial portion of a cylinder. This partial portion of a cylinder has a cylindrical exterior surface 84, and cylindrical interior surface 86 and angled edges, or ramps 87, that extend from the ends 82 to the interior surface 86. Also, the ramps 87 of wedges 16 are positioned at an angle that is similar or identical to the ramps 52, 70 of the main body 12 and plug 14, respectively.

The binder 18 is formed of any device such as a flexible 0-ring, rubber band or any other flexible device that is resilient and has a tendency to pull the adjacent wedges 16 together while allowing separation of the wedges 16 from one another when force is applied.

Fastener: System 10 also includes fastener 20. Fastener 20 is formed of any suitable size, shape and design. In the arrangement shown, fastener 20 is formed of a screw or bolt that includes an elongated shaft 100 having a head 102 at its forward most end and terminates at a threaded end 104. The diameter of head 102 is sized and shaped to be received within bore 44 of main body 12 prior to shoulder 46. That is, shaft 110 extends through the main body 12 while head 102 is stopped by or caught by shoulder 46. When head 102 engages shoulder 46, fastener 20 is fully inserted within main body 12. Head 102 also includes a feature 106 that is used for rotating fastener 20 such as a hex-head feature, square-head feature, Philips-head feature, flat-head feature or any other feature that is used to rotate shaft 20.

Assembly and Operation: A plurality of wedges 16 are positioned in side 90 to side 90 alignment thereby forming a partial portion of a cylinder having inwardly sloped ends that connect to a central bore. Once aligned in this manner, binder 18 is positioned around all the wedges 16 in groove 88 thereby holding the wedges 16 together and forming the expansion mechanism 15.

Plug 14 is positioned at the rearward end 82 of the connected wedges 16. In this position the ramped surface 87 of wedges 16 are in approximate flush alignment with the ramped surface 70 of plug 14. Also, in this arrangement the bore 64 of plug 14 aligns with the bore 92 formed by the interior surfaces 86 of wedges 16.

Protrusion 48 of main body 12 is positioned at the forward end 82 of the connected wedges 16. In this position the ramped surface 52 of protrusion 48 is in approximate flush alignment with the ramped surfaces 87 of wedges 16. Also, in this arrangement the bore 44 of main body 12 aligns with the bore 92 formed by the interior surfaces 86 of wedges 16.

Once the connected wedges 16, plug 14 and main body 12 are positioned in central alignment with one another around center axis 42, fastener 20 is inserted through the components 12, 14, 16 thereby connecting them together. More specifically, the threaded end 104 of fastener 20 is inserted into bore 44 of main body 12 until head 102 engages shoulder 46. At this point, the threads of threaded end 104 of fastener 20 engage the threads in the bore 64 of plug 14 and the fastener is rotated by feature 106 thereby threadably engaging the two components 20, 14 together.

As the fastener 20 is rotated in one direction the plug 14 is pulled towards the main body 12. This forces the ramped surfaces 87 of wedges 16 over the ramped surface 52 of protrusion 48 and the ramped surface 70 of plug 14. As the plug 16 is pulled closer and closer to the main body 12 by fastener 20 the wedges 16 are forced to expand in relation to one another.

When the plug 14, expansion mechanism 15 and protrusion 48 of main body are positioned within the open end of a the handle bars of a bicycle 24 and the fastener 20 is tightened, this causes the wedges 16 to expand until the exterior surface 84 of the wedges 16 engage the interior surface of the handle bars. In this way, the system 10 is attached to the bicycle 24. Care is taken to ensure that the notch 32 and lip 40 are positioned at the bottom center when installed on the bicycle 24, which allows for the easiest use.

Once installed, this arrangement ensures that a bottle opener is never left behind when going on a ride. In addition, while the system 10 is very small, because it is connected to the larger handle bars of bicycle 24, a great amount of leverage is found by this attachment. As such, this bottle opener system 10, which is of very small stature, does not suffer from the deficiencies that other small stature bottle openers suffer from. That is, it is not easily misplaced, lost or left behind and it has a substantial amount of leverage that allows a bottle cap to be easily removed.

Advertising: When in place on the handle bars of bicycle 24, advertising 108 is placed on the exterior surface 30 of main body 12. This cylindrical exterior surface 30 is perfect for being etched with a name or logo, for being painted or for housing a sticker. This advertising provides a great amount of cross branding opportunities for this product as a promotional item. Examples of advertising 108 include a sticker placed onto the exterior surface of main body 12, a logo or design which is painted onto the exterior surface of main body 12, a logo or design which is etched into the exterior surface of main body 12, or any other form of advertising.

Rotation Prevention: To effectively work, the plug 14 moves forward and rearward with respect to the main body 12. To accomplish this, the plug 14 does not rotate as the fastener 20 is rotated. To help ensure the plug 14 remains stationary and does not rotate, fins, grooves or guides 110 may be placed on any of the ramped surfaces 52, 70, 87 of protrusion 48, plug 14 and/or wedge 16. These guides 110 may be an arrangement of mating ridges and corresponding grooves, they may be a plurality of fins or ridges, or they may be any other feature that helps to prevent rotation while allowing for forward to back sliding movement. Use of guides 110 helps to ensure that the plug 14 does not rotate when the fastener 20 rotates thereby ensuring that the plug 14 is laterally moved when fastener 20 is rotated thereby ensuring quick and easy installation and removal.

Not Limited To Bicycles: While the system 10 is described herein as being used in association with the open end of handlebars of a conventional bicycle, the system 10 is not so limited. Any reference to use with handle bars of bicycles is merely one example of countless possible uses. It is hereby contemplated that the system can be used in association with bicycles, motorcycles, snowmobiles, strollers, golf carts (powered and unpowered), frames, or any other mechanical device, object, or the like.

In another arrangement, system 10 can be installed in any object into which a hole can be drilled that can receive plug 14 and expansion mechanism 15. Examples include tables, bars, counter tops, fence posts, picnic tables, work benches, walls, or any other object. This allows the installation of a system 10 in any convenient position or place such as in an in-home bar, at a restaurant, in one's garage or “man cave” or any other convenient location.

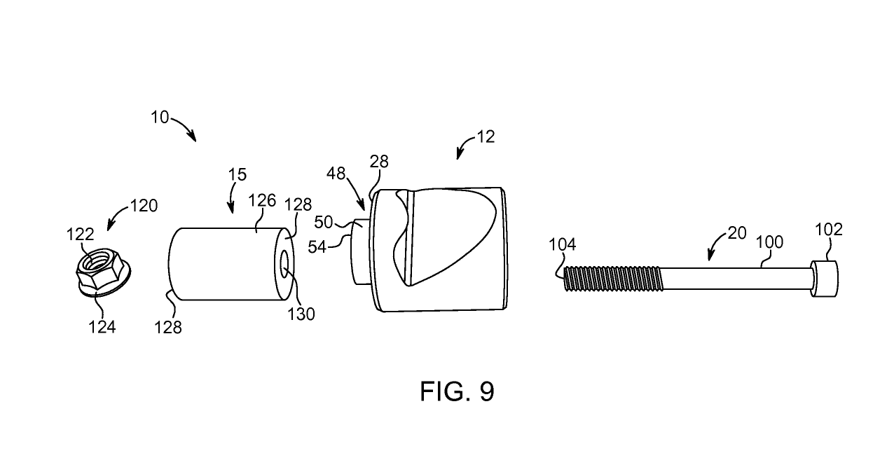

Alternative Arrangement: With reference to FIG. 9 an alternative arrangement is presented. In this alternative arrangement, plug 14 is replaced with a conventional nut 120 having a threaded bore 122 and a flange 124 connected thereto. In an alternative arrangement, flange 124 is replaced with a separate washer, however by having nut 120 and flange 124 being formed of a single piece eliminates an extra part and streamlines the assembly process, however both arrangements are hereby contemplated for use.

Also, in this alternative arrangement, expansion mechanism 15 is formed of an elongated cylindrical tube 126. Cylindrical tube 126 is formed of any compressible material such as rubber, plastic, gel, composite, or any combination thereof, or the like. Cylindrical tube 126 has a generally smooth and cylindrical exterior surface that terminates in ends 128 that extend in approximate perpendicular alignment to the length of cylindrical tube 126. Cylindrical tube 126 includes a centrally positioned bore 128 that extends from end 128 to end 128 through approximately the center of cylindrical tube 126.

Also, in this arrangement, the exterior surface 50 of protrusion 48 of main body 12 extends rearward from rear face 28 a short distance before terminating in rear wall 54 which connects to exterior surface 50 in approximate perpendicular alignment.

When assembled, the bore 44 of main body 12 aligns with the bore 130 of cylindrical tube 126 which aligns with the threaded bore 122 of nut 120. In this arrangement, the plane formed by flange 124 of nut 120, the ends 128 of cylindrical tube 126 and the rear wall 54 of main body 12 are positioned in approximate parallel alignment and aligned in flush end-to-end alignment. Once aligned in this manner, fastener 20 is inserted through the bore 44 of main body 12, the bore 130 of cylindrical tube 126 and the threaded bore 122 of nut 120. Next the fastener is rotated such that the threaded end 104 threadably engages the threaded bore 122 of nut 120 thereby pulling or pushing nut 120 towards or away from main body 12, depending on the direction of rotation.

As the nut 120 is pulled toward the main body 12 this causes the lateral length of cylindrical tube 126 to compress. This lateral compression causes the thickness of cylindrical tube 126 to expand. When inserted in the end of a bicycle handle bar or in a hole drilled into a bar or other opening, when the cylindrical tube laterally compresses by increases in thickness, this causes the cylindrical tube to bind to the interior surface of the handle bar or opening thereby preventing removal of main body 12.

By utilizing conventional parts, such as nut 120, and by simplifying the design, by using a cylindrical tube 126 as expansion mechanism 15, this alternative arrangement presented in FIG.

9 simplifies the design of the system 10 and thereby reduces the manufacturing cost of the system 10, simplifies the assembly process and eliminates the need for specialized parts and pieces as well as manufacturing steps.

While the term “nut” is used herein to describe the item presented as reference numeral 120, the term is to be broadly defined. That is the term nut (as used with respect to reference numeral 120) and the term plug (as used with respect to reference numeral 14) are to be used interchangeably herein unless specifically stated otherwise. That is, the terms nut and plug are meant to identify an item that is placed on the end 104 of fastener 20 that threadably receives the fastener 20 in a bore therein and serves to cause expansion mechanism to expand and contract when fastener 20 is rotated.

From the above discussion and the accompanying drawings and claims it will be appreciated that the improved attachable bottler opener system and method presented offers many advantages over the prior art. That is, the attachable bottler opener system and method presented; improves upon the state of the art; is convenient to use; is hard to misplace or leave behind; can easily be attached to various devices such as bicycles; is durable; has a long useful life; has an intuitive design; is formed of a minimum number of parts; has a rugged design; is light weight; is relatively inexpensive; provides value, utility and novelty to the user; can easily and efficiently be used to open a bottle in a comfortable and convenient manner; is sized and shaped to be quickly and easily installed on conventional handle bars of bicycles; is adjustable; provides for a convenient place for advertising and promotion; can be easily removed and reinstalled, among countless other improvements and advantages.

It will be appreciated by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in light thereof will be suggested to persons skilled in the art and are to be included within the spirit and purview of this application.

What is claimed:

1. A bottle opener system comprising:
a main body;
the main body having a lip therein;
an expansion mechanism;
a fastener extending through at least a portion of the main body, and the expansion mechanism; and
wherein when the expansion mechanism is inserted in an opening and the fastener is rotated in a first direction the expansion mechanism expands thereby tightening the expansion mechanism against the opening.

2. The bottle opener system of claim 1 wherein when the fastener is rotated in a second direction, opposite the first direction, the expansion mechanism contracts.

3. The bottle opener system of claim 1 wherein the expansion mechanism is positioned within an open end of the handle bars of a bicycle.

4. The bottle opener system of claim 1 wherein the expansion mechanism is formed of a plurality of wedges.

5. The bottle opener system of claim 1 wherein the expansion mechanism is formed of a compressible cylindrical tube.

6. The bottle opener system of claim 1 further comprising a plug threadably connected to an end of the fastener opposite the expansion mechanism.

7. The bottle opener system of claim 1 further comprising a nut threadably connected to an end of the fastener opposite the expansion mechanism.

8. The bottle opener system of claim 1 further comprising, a nut or plug threadably connected to an end of the fastener opposite the expansion mechanism, wherein when the fastener is rotated in the first direction, the nut or plug moves toward the main body.

9. The bottle opener system of claim 1 further comprising, a nut or plug threadably connected to an end of the fastener opposite the expansion mechanism, wherein when the fastener is rotated in a second direction, opposite the first direction, the plug moves away from the main body.

10. The bottle opener system of claim 1 wherein the expansion mechanism is formed of a plurality of wedges with a binder placed around the wedges thereby holding the wedges together.

11. The bottle opener system of claim 1 wherein advertising is placed on an exterior surface of the main body.

12. A method of using a bottle opener, comprising the steps of:
providing a bottle opener having a lip therein;
connecting a plug to the main body;
placing an expansion mechanism adjacent to the main body;
placing a nut or plug adjacent the expansion mechanism;
extending a fastener through the main body and the nut or plug; and
rotating the fastener in a first direction thereby causing the expansion mechanism to expand.

13. The method of claim 12 further comprising the step of inserting the nut or plug, the expansion mechanism and a portion of the main body in an open end of handle bars of a bicycle.

14. The method of claim 12 further comprising the step of rotating the fastener in a second direction, opposite the first direction, thereby causing the expansion mechanism to contract.

15. The method of claim 12 further comprising the step of placing a bottle cap connected to a bottle under the lip and rotating the bottle thereby removing the bottle cap from the bottle.
